(19) United States
(12) Patent Application Publication
(10) Pub. No.: US 2026/0328164 A1
(43) Pub. Date: Oct. 22, 2026

(54) ROCKET PROBULSION SYSTEM, METHOD, AND A SPACE VEHICLE

(71) Applicant: ArianeGroup GmbH, TAUFKIRCHEN (DE)

(72) Inventor: Christian HESSEL, TAUFKIRCHEN (DE)

(21) Appl. No.: 19/113,795

(22) PCT Filed: Sep. 20, 2023
(86) PCT No.: PCT/EP2023/075945

§ 371 Date: Mar. 20, 2025

(30) Foreign Application Priority Data
Sep. 26, 2022 (EP) 22197690.5

(51) Int. Cl. F02K 9/48; B64G 1/00; B64G 1/40; F02K 9/42; F02K 9/94

(52) U.S. Cl. CPC F02K 9/48; B64G 1/002; B64G 1/401; F02K 9/425; F02K 9/94

(57) ABSTRACT

A rocket propulsion system comprising a first tank filled with a fuel and a second tank filled with an oxidizer, such as liquid hydrogen peroxide, for purposes of supplying at least one preferably repeatedly ignitable main engine of the rocket propulsion system. A gas generator is assigned to the rocket propulsion system, to generate vaporous hydrogen peroxide. After flowing through at least one turbine, the hydrogen peroxide can, at least partially, be supplied to a separator unit, which is designed to break down vaporous hydrogen peroxide into water vapor and gaseous oxygen. Alternatively or additionally, the hydrogen peroxide can be supplied to an electrolysis unit, which is designed to generate gaseous oxygen and gaseous hydrogen from the hydrogen peroxide supplied to it, and/or from water vapor that is located downstream. Also a method for operating the rocket propulsion system and a space vehicle.

### CROSS-REFERENCES TO RELATED APPLICATIONS

This application is a national phase of International Patent Application No. PCT/EP2023/075945, filed on Sep. 20, 2023, which claims the benefit of European Patent Application No. 22197690.5, filed on Sep. 26, 2022, the entire disclosures of which are incorporated herein by way of reference.

### FIELD OF THE INVENTION

The invention relates firstly to a rocket propulsion system comprising a first tank and a second tank, wherein the first tank is filled with a fuel, and the second tank is filled with an oxidizer, such as liquid hydrogen peroxide, for purposes of supplying at least one, preferably re-ignitable, main engine of the rocket propulsion system. In addition, the invention relates to a method for the operation of such a rocket propulsion system, and to a space vehicle with such a rocket propulsion system.

### BACKGROUND OF THE INVENTION

Remote sensing or reuse are major challenges for autonomous propulsion systems of rockets and space vehicles. In the case of long-term missions, cryogenic space vehicles are not always the first choice, as great efforts are required to keep the cryogenic liquids in liquid form (the so-called “boil-off” problem) so as to ensure a relatively high density and thus small propellant tanks. Conventional, storable propellants are of known prior art for remote sensing and long operating times in orbit (satellites). Toxic propellants such as NTO (=dinitrogen tetroxide) or MMH (=monomethyl hydrazine) are often used for rocket stages or satellites. These propellants have the disadvantage that they are no longer environmentally compliant with national regulations. In addition, there are disadvantages in the remote sensing of the Moon and near-Earth planets, such as Mars, when considering reusable or returnable systems. For such reusable or returnable systems, the ability to generate on site the propellants and working gases required for the return flight is of major importance. However, as representatives of these conventional types of propellant, NTO and MMH can only be synthesized on Mars or the Moon at great expense, or not at all. Conventional high-performance, high-pressure, gases, such as helium, are also only accessible there under difficult conditions, and are already becoming increasingly scarce on Earth.

One of the objects of the invention is to specify an autogenous rocket propulsion system that operates with environmentally-compatible propellants, and utilizes the particular properties of hydrogen peroxide for other additional functions of the rocket propulsion system. Further objects of the invention are the specification of a method for the operation of such a rocket propulsion system, and a space vehicle equipped with such a rocket propulsion system.

### SUMMARY OF THE INVENTION

These objects may be achieved by a rocket propulsion system in accordance with one or more embodiments described herein, a method in accordance with one or more embodiments described herein, and a space vehicle in accordance with one or more embodiments described herein.

Here one of the objects is first achieved in that the rocket propulsion system is assigned a gas generator that is designed to produce vaporous hydrogen peroxide, which is supplied completely or partially to at least one turbine. After it has flowed through the turbine, at least some of the hydrogen peroxide flowing through can be supplied to a separator unit, which is designed to break down the vaporous hydrogen peroxide into water vapor and gaseous oxygen, and/or the hydrogen peroxide flowing through can be supplied to an electrolysis unit, by means of which gaseous oxygen and gaseous hydrogen are produced from the vaporous hydrogen peroxide, or from water vapor that is located downstream.

By this means, the rocket propulsion system can be operated with environmentally-compatible propellants that can be synthesized with relatively little effort, even under difficult environmental conditions, such as those prevailing on the Moon or near-Earth planets such as Mars. In addition, the non-toxic oxidizer ensures that space vehicles, rocket stages, satellites or similar that are equipped with the inventive rocket propulsion system can be reused. By this means, it may also be possible to achieve returnable and reusable space units. The initially liquid hydrogen peroxide is catalytically converted in the gas generator into vaporous hydrogen peroxide or a so-called “working gas mixture”, which is, at least partially, split into water vapor, that is to say, water and oxygen, in the separator unit, and/or is directly or subsequently split into oxygen and hydrogen in the electrolysis unit. The separator unit located downstream of the gas generator can separate the working gas mixture electrothermally or fluid-dynamically with the aid of centrifugal force. By virtue of the utilization of these decomposition products of the hydrogen peroxide, an optimized operation of the autogenous rocket propulsion system and its subsidiary and ancillary systems can be achieved. The tanks can, for example, be pressurized with oxygen and/or water vapor, making a conventional inert gas system for tank pressurization completely, or at least partially, unnecessary. The tank pressurization ensures that the main engine can be reliably ignited repeatedly.

In an advantageous configuration, the gas generator can be used to supply at least one position control thruster with vaporous hydrogen peroxide. This eliminates the need for a separate supply to the position control thrusters. The turbine can have a bypass branch, which is designed, amongst other tasks, to influence the volumetric flow of the gaseous hydrogen peroxide flowing through the turbine, in particular, that is to say, to increase or reduce it.

An electrical generator, and/or at least one fuel pump, and/or an oxidizer pump, can preferably be driven by means of the at least one turbine. As a consequence, an electrical generator is available that can be used, for example, to supply the rocket propulsion system and its subsidiary systems, and/or the entire space vehicle, with electrical energy. The electrical generator can also, for example, be used to supply an optional electrolysis unit with the necessary electrical energy. In a fluid-dynamic mode of operation of the separator unit, the turbine can also drive the separator unit directly by mechanical rotation, whereas in a thermal mode of operation, the power generated by the electric generator is required to operate the separator unit. It is also possible to drive a fuel pump, and/or an oxidizer pump, electrically, or directly by mechanical rotation, by means of the turbine.

In an advantageous configuration, provision is made such that the first tank can be pressurized by means of a water vapor leg of the separator unit, and the second tank can be pressurized by means of an oxidizer leg of the separator unit. By this means it is easy to pressurize the tanks with decomposition products of the hydrogen peroxide, that is to say, products of the oxidizer that is already present. In the context of the present description, the term “leg” defines a pipeline, or a plurality of pipelines, the arrangement of which, in the case of a plurality of lines, can resemble the topology of a cable harness or line harness, whereby each leg, or each line, carries the same chemical substances, such as hydrogen (“H2” herein occasionally), oxygen (“O2” herein occasionally), hydrogen peroxide (“H2O2” herein occasionally), fuel, etc., and whereby these can be present in different physical states.

Forms of embodiment in which the rocket propulsion system has at least one vessel with an inert gas for at least supplementary pressurization of the first and/or second tank, are advantageous. Consequently, it is possible to pressurize the tanks independently of the decomposition products of the hydrogen peroxide.

In accordance with advantageous forms of embodiment, the second tank can be pressurized by means of an oxidizer leg of the separator unit, an electrolysis unit is connected to the separator unit by means of a water vapor leg, and the electrolysis unit has a high-energy hydrogen and oxygen leg. By virtue of the electrolysis unit, which preferably operates at high-temperature and high-pressure, it is also possible to extract hydrogen and oxygen from the water, or water vapor separated with the aid of the separator unit. The hydrogen and the oxygen can be used, for example, to supply a position control thruster, which can thereby generate a significantly higher thrust, or specific impulse, compared to a supply with hydrogen peroxide.

In accordance with advantageous forms of embodiment, an inventive rocket propulsion system, in the variant in which the vaporous hydrogen peroxide, after flowing through the at least one turbine, can, at least partially, be supplied to an electrolysis unit, has at least one working gas leg for a working gas mixture exiting from the turbine, that is to say, for mixed proportions of water vapor and oxygen. The working gas leg then preferably comprises on the one hand an oxidizer leg for the pressurization of the second tank. On the other hand, in such forms of embodiment, the working gas leg preferably comprises a conversion leg, in which the working gas mixture can be supplied to the electrolysis unit for the operation of the latter. Here the electrolysis unit preferably has a high-energy hydrogen and oxygen leg. By virtue of the electrolysis unit, which preferably operates at high temperature and high pressure, it is also possible to extract hydrogen and oxygen from the existing water vapor/oxygen mixture from the working gas in the conversion leg. The hydrogen and oxygen can be used, for example, to supply a position control thruster, which by this means can generate a significantly higher thrust or specific impulse in comparison to one supplied with hydrogen peroxide.

A first high-pressure accumulator is preferably assigned to the high-energy hydrogen leg, and a second high-pressure accumulator is preferably assigned to the high-energy oxygen leg. As a consequence, a buffer or storage action is achieved in the hydrogen and oxygen leg.

The first tank can preferably be pressurized using the high-energy hydrogen leg. This eliminates the need for separate pressurization with an inert gas, which would otherwise be necessary.

In an advantageous development, provision is made for a main nozzle of the main engine to be charged with hydrogen by means of the first high-pressure accumulator, and with oxygen by means of the second high-pressure accumulator. By this means it is possible, for example, to increase the thrust of the main engine, and to control the thrust vector of the main engine so as to change the flight path, etc., when required.

The at least one position control thruster, at least one defensive unit, and/or a high-energy unit/high-pressure unit can preferably be supplied by means of the first and second high-pressure accumulators. Amongst other features, this can increase the performance of the position control thrusters, in comparison to supplying them with pure hydrogen peroxide. In addition, a defensive unit such as a recoilless light gas weapon, or other high-energy units, can be supplied. The defensive unit can also be a net harpoon, or a similar device, for capturing satellites that have got out of control, for example, before there is a risk of collision with other objects in the orbit. The high-pressure unit can take the form of an interface to an inflatable structure, such as a habitat.

An oxygen storage unit is preferably assigned to the oxidizer leg of the separator unit, and a water storage unit is preferably assigned to the water vapor leg of the separator unit. As a consequence, an accumulator is available for supplying a life support system of the space vehicle with water and oxygen.

Another object cited earlier may be furthermore achieved by a method for the operation of the rocket propulsion system, in which the fuel is supplied to the main engine via a first main supply line, and the liquid hydrogen peroxide is at least partially tapped from a second main supply line of the main engine, and supplied to the gas generator. As a consequence, only a relatively small proportion of the liquid hydrogen peroxide may be supplied to the gas generator, while the remaining (main) proportion of the liquid hydrogen peroxide is used to generate thrust, after the main nozzle and the combustion chamber of the main engine have been cooled. The liquid hydrogen peroxide supplied via the second main supply line can, for example, be divided between the main engine and the gas generator for purposes of the catalytic conversion of the liquid hydrogen peroxide into gaseous or vaporous hydrogen peroxide, by means of a controllable distributor (a so-called “divider”), or a controllable three-way valve with corresponding hydraulic ports, or similar. If the main engine operates with fuel cooling, a first proportion of the hydrogen peroxide is supplied directly to the main engine, while the remaining (residual) second proportion is returned to the combustion chamber of the main engine, after passing through the turbine. The ratio of the distribution between the first and second proportions depends on the requirements of the subsidiary systems of the rocket propulsion system for pressurization of the tanks and energy conversion.

In accordance with a development of the method, the vaporous hydrogen peroxide exiting from the gas generator is at least partially supplied to the turbine. This makes it possible, amongst other features, to control the power output of the turbine. The proportion of the vaporous hydrogen peroxide not supplied to the turbine can be supplied to the combustion chamber of the main engine via a suitable distribution unit. In principle, only a proportion of the hydrogen peroxide is supplied to the turbine, depending on the deployment scenario of the rocket propulsion system. In order to achieve the highest possible specific power output, as much hydrogen peroxide as possible should be supplied to the main engine, or returned to it after passing through the turbine with the aid of a suitable return line (not illustrated in the drawings). This ratio can vary as a function of the deployment scenario. The pure pressurization requirement of the tanks can turn out to be lower than the power output required for the subsidiary systems or auxiliary systems, and thus the requirement for the oxidizer or hydrogen peroxide tapped from the main supply line of the main engine. The highest possible proportion of the oxidizer should always be used directly to supply the main engine, that is to say, it should remain in the so-called main cycle in order primarily to generate thrust and impulse power.

A rocket propulsion system in accordance with the invention can preferably have a propulsion cycle with which it can be operated in a monopropellant mode when the inactive fuel leg is switched off. This enables an improved throttling capability to be achieved in the main propulsion system. Alternatively or additionally, the rocket systems can have an engine cycle with which, in a switched-off state of the main engine, the rocket propulsion system can be used to operate (possibly only) the position control system, to pressurize the fuel tanks, and/or (with a suitably developed interface) to provide working gas for external systems such as a space station or a habitat (e.g. inflatable structures). Such an engine cycle can be implemented by means of suitable subsidiary systems and/or interfaces.

In addition, another object cited earlier is achieved by a space vehicle in accordance with the invention, which is equipped with at least one rocket propulsion system in accordance with the invention (in particular in one of the forms of embodiment cited). As a consequence, the optimized, autogenous rocket propulsion system can be used for a space vehicle.

### BRIEF DESCRIPTION OF THE DRAWINGS

The invention is explained in more detail in the following description, with reference to the examples of embodiment illustrated in the figures. In the figures, the same design elements have the same reference numbers in each case. Dashed lines symbolize in each case optional lines or components. In the Figures:

FIG. 1 shows a schematic flow diagram of a first form of embodiment of a rocket propulsion system,

FIG. 2 shows a schematic flow diagram of a second form of embodiment of a rocket propulsion system,

FIG. 3 shows a schematic flow diagram of a third form of embodiment of a rocket propulsion system, and

FIG. 4 shows a schematic flow diagram of a fourth form of embodiment of a rocket propulsion system.

### DETAILED DESCRIPTION OF THE PREFERRED EMBODIMENTS

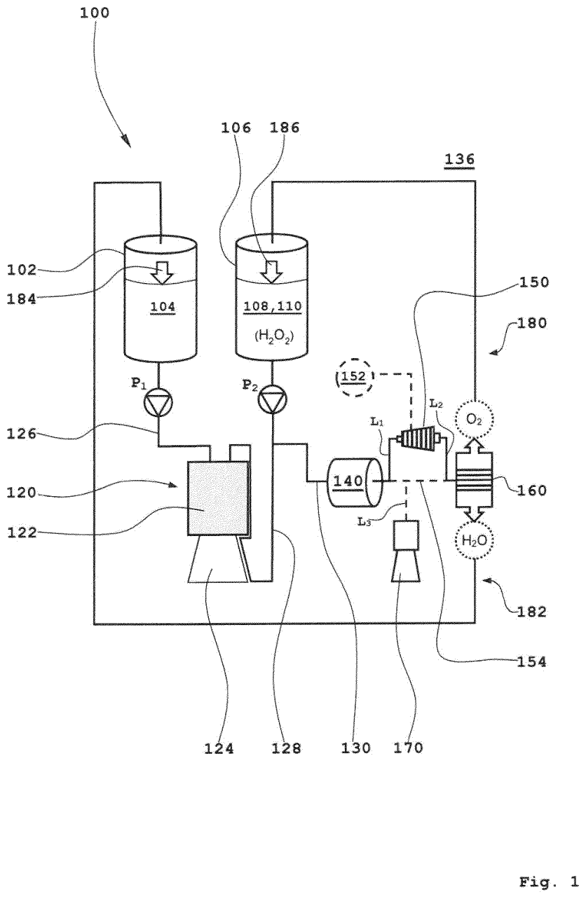

FIG. 1 illustrates a schematic flow diagram of a first form of embodiment of a rocket propulsion system. A rocket propulsion system 100 comprises, inter alia, a first tank 102 for a fuel 104, and a second tank 106 for an oxidizer 108, which preferably takes the form of hydrogen peroxide 110. The fuel 104 takes the form of any liquid and storable fuel, such as paraffin, which, like the hydrogen peroxide 110 used as an oxidizer 108, also has the lowest possible toxicity.

The fuel 104 can be supplied by means of a fuel pump P1 to a combustion chamber 122 of at least one main engine 120 by way of a main supply line 126. Accordingly, the oxidizer 108, that is to say, here preferably the hydrogen peroxide 110, can also be supplied to the combustion chamber 122 by means of an oxidizer pump P2 and a second main supply line 128, after passing through the main nozzle 124. After intimate mixing of the fuel 104 and the oxidizer 108 in the combustion chamber 122 of the main engine 120, their combustion takes place to generate thrust.

A gas generator 140 is connected to the second main supply line 128 by means of a branch line 130. The volumetric flow of liquid hydrogen peroxide supplied to the gas generator 140 by means of the branch line 130 can be varied by means of a controllable distributor, which is not shown in the figures in the interests of a better overview. The gas generator 140 is designed to generate vaporous hydrogen peroxide, preferably catalytically; this can be supplied to a turbine 150 or another item of turbomachinery by means of a line L1. After flowing through the turbine 150, the hydrogen peroxide reaches a separator unit 160 by means of a further line L2.

The lines L1,2 are connected by means of a bypass branch 154 in order to create a bypass for the turbine 150, whereby the volumetric flow of the hydrogen peroxide passing through the turbine 150 can be adjusted by means of valves, etc. (not shown). Here another optional line L3 is connected to the optional bypass branch 154 as an example; this is used to supply a position control thruster 170 with vaporous hydrogen peroxide. Valves (not shown) are also provided in the line L3 so as to be able to control the thrust or the specific impulse of the position control thruster 170 in a differentiated manner.

The vaporous hydrogen peroxide flowing to the separator unit 160, via the line L2 or the optional bypass branch 154 from the gas generator 140, is split in the latter into oxygen O2, and water or water vapor (“H20” herein occasionally); this is illustrated graphically by the two dotted circles and the chemical symbols O2 and H2O entered in the latter. The two dotted circles serve merely to illustrate the fact that within an oxidizer line 180, in the form of a pipe or a conduit, and a water vapor line 182, each of which is connected to the separator unit 160, the above-mentioned substances (O2, vaporous or gaseous H20) can be discharged from the separator unit 160 in the direction of the two tanks 102, 106 in order to pressurize the latter.

The first tank 102 containing the fuel 104 can preferably be pressurized with the separated water vapor by means of the water vapor line 182 connected to the separator unit 160, and the second tank 106 containing the liquid hydrogen peroxide 110 can correspondingly be pressurized with the separated gaseous oxygen by means of an oxidizer line 180 connected to the separator unit 160, as illustrated in each case by the two white arrows 184, 186.

The turbine 150 can drive an optional electrical generator 152 (shown by a dashed line) in order to generate electrical energy. The fuel pump P1 and the oxidizer pump P2 can be driven directly by the turbine 150, or, if an electric generator 152 is present, can be driven electrically with the aid of electric motors (not shown).

The separator unit 160 located downstream of the gas generator 140 can separate the supplied vaporous hydrogen peroxide, or the “working gas mixture”, electrothermally or fluid-dynamically with the aid of centrifugal force. In the case of an electrothermal mode of operation of the separator unit 160, the electrical energy obtained with the aid of the generator 152 is utilized. If, on the other hand, the splitting of the hydrogen peroxide into oxygen and water or water vapor is based on the fluid-dynamic operating principle utilizing centrifugal force, the separator unit 160 can be driven directly by the turbine 150 by means of mechanical rotation.

Hydrogen peroxide 110 as the oxidizer used here in the rocket propulsion system 100 is largely environmentally compatible, non-toxic, and also comparatively easy to synthesize, even under difficult environmental conditions, such as those prevailing on the Moon and near-Earth planets such as Mars. In conjunction with a storable liquid fuel 104 with similar properties, a space vehicle 136 equipped with the rocket propulsion system 100 can also be reused or returned to Earth under certain circumstances. In addition, the splitting of hydrogen peroxide 110 within the rocket propulsion system 100 by means of the separator unit 160 into oxygen O2 and vaporous water vapor H2O allows the first and second tanks 102, 106 to be pressurized simultaneously. Therefore, in the first form of embodiment in FIG. 1, no additional tank with an inert gas such as helium, etc. is required for the pressurization of the tanks 102, 106. The space vehicle 136 can take the form, for example, of a rocket, a satellite, a space capsule, a space station, or similar.

Furthermore, valves or actuators, which are not shown in the interests of clarity, can be provided in all lines or pipework of the rocket propulsion system 100 as required; these can be controlled by an electronic controller or regulator, likewise not shown, of the rocket propulsion system 100 and/or the space vehicle 136. The same applies to connection nodes between two or more lines, or connection nodes formed by (multi-path) valves. Here the at least one electronic controller and/or regulator is designed to control all sequences or processes within the rocket propulsion system 100.

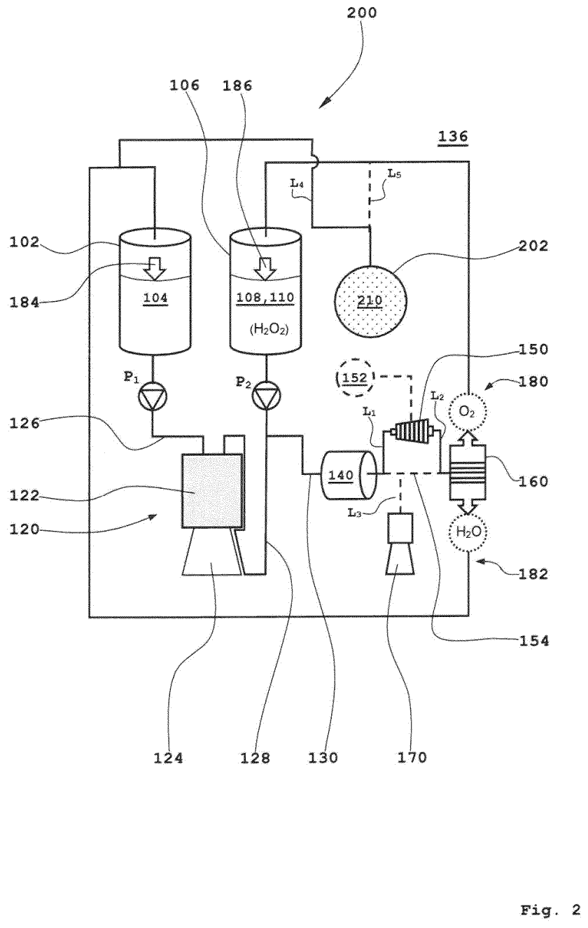

FIG. 2 illustrates a schematic flow diagram of a second form of embodiment of a rocket propulsion system. The second form of embodiment of a rocket propulsion system 200 once again comprises the first and second tanks 102, 106, whereby the first tank 102 is filled with the fuel 104, and the second tank 106 is filled with the oxidizer 108 in the form of liquid hydrogen peroxide 110. The fuel 104 can be supplied directly via the first main supply line 126 to the combustion chamber 122 of the main engine 120 by means of the fuel pump P1. Correspondingly, the oxidizer 108 can be supplied via the second main supply line 128 to the combustion chamber 122 by means of the oxidizer pump P2, whereby the oxidizer 108, or the hydrogen peroxide 110, cools the combustion chamber 122 and the main nozzle 124 before entering the combustion chamber 122. Within the combustion chamber 122, the fuel 104 and the gaseous oxidizer 108 are intimately mixed and combusted so as to generate an impulse.

By means of the branch line 130 connected to the second main supply line 128, an adjustable proportion of the liquid hydrogen peroxide 110 can in turn be transferred to the gas generator 140 in order to generate gaseous hydrogen peroxide catalytically. The gaseous hydrogen peroxide 110 can be supplied to and discharged from the turbine 150 by means of the lines L1,2, and then passes into the separator unit 160. The gaseous hydrogen peroxide produced by the gas generator 140 can partially or completely bypass the turbine 150 with the aid of the bypass branch 154, and thus can, at least partially, also be led directly into the separator unit 160. With the aid of the bypass branch 154 and the line L3, the position control thruster 170 can still be supplied with gaseous hydrogen peroxide when required. The oxidizer line 180 and the water vapor line 182, which serve to pressurize the fuel 104 and the oxidizer 108 stored in the tanks 102, 106, are in turn connected to the separator unit 160. The optional electrical generator 152 can be driven by means of the turbine 150 so as to generate electrical energy.

In a major difference from the first form of embodiment, the second form of embodiment of the rocket propulsion system 200 has a vessel 202, which is filled with an inert gas 210, such as helium, neon, argon, etc. By means of a line L4, which is connected to the water vapor line 182, the first tank 102 can be pressurized, that is to say, charged, with the inert gas 210. Furthermore, the second tank 106 can also be charged with the inert gas 210 by means of an optional line L5. As illustrated in FIG. 2, the second line L5 can branch off from the line L4, or can be connected directly to the vessel 202 independently of the line L4 (not shown).

One advantage, amongst others, of the second form of embodiment of the rocket propulsion system 200 is to be seen in the fact that in addition to the possibility of pressurizing the tanks 102, 106 with the fission products (O2, H2O) of the hydrogen peroxide, that is to say, one of the fuel components of the rocket propulsion system 200, there is the possibility of at least supplementary pressurization of at least one of the tanks 102, 106 with the inert gas 210 from the vessel 202. The pressurization of the tanks 102, 106 again takes place in the direction of the arrows 184, 186.

In accordance with a method for the operation of the rocket propulsion system 200, provision is made for the fuel 104 to be supplied to the main engine 120 via the first main supply line 126, and the liquid hydrogen peroxide is at least partially tapped, that is to say, diverted, from the second main supply line 128 of the main engine 120 and supplied to the gas generator 140. As a consequence, a mechanical power output of the turbine 150 can be varied within wide limits under the control of the controller and/or regulator. The vaporous hydrogen peroxide exiting from the catalytic gas generator 140 can, in accordance with the method, be at least partially bypassed around the turbine 150 and/or supplied to the position control thruster 170 with the aid of the bypass branch 154; this takes place under the permanent control of the controller and/or regulator. This means that the gaseous hydrogen peroxide escaping from the gas generator 140—apart from the quantities supplied to the position control thruster 170—passes completely via the turbine 150, and/or the bypass branch 154, into the separator unit 160.

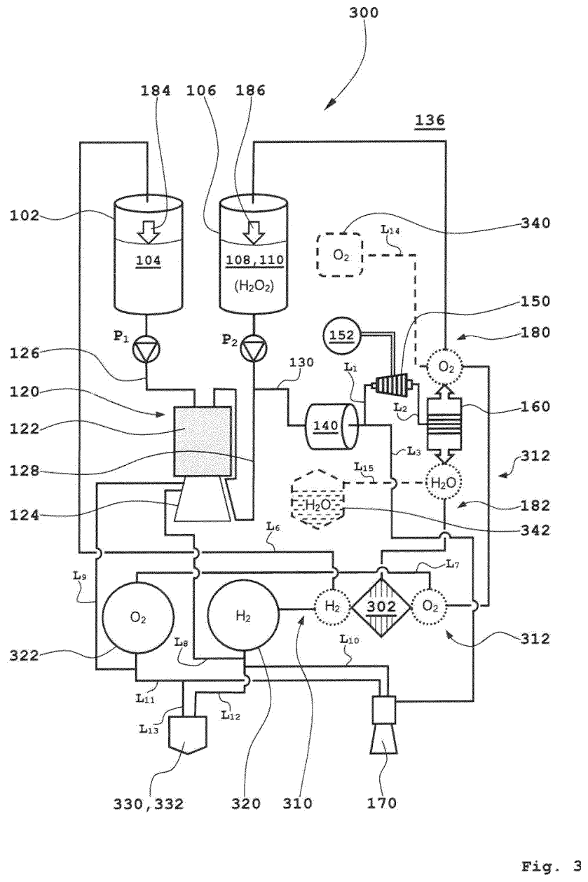

FIG. 3 illustrates a schematic flow diagram of a third form of embodiment of a rocket propulsion system. This form of embodiment of a rocket propulsion system 300 again comprises the two tanks 102, 106, which are, at least partially, filled with the fuel 104 and the oxidizer 108 in the form of hydrogen peroxide 110. The fuel 104 can be supplied by means of the fuel pump P1 via the first main supply line 126, and the oxidizer 108 can be supplied by means of the oxidizer pump P2 via the second main supply line 128, into the combustion chamber 122 of the main engine 120, whereby the cooling of the main nozzle 124 or the nozzle skirt and the combustion chamber 122 takes place by means of the oxidizer 108 or the hydrogen peroxide 110.

The gas generator 140 is once again connected to the second main supply line 128 by means of the branch line 130. The turbine 150 can be charged with gaseous hydrogen peroxide from the gas generator 140 by means of the line L1; this can be discharged into the separator unit 160 via the line L2 after passing through the turbine 150. In contrast to the first two forms of embodiment, the optional bypass branch 154 of the turbine 150 that is shown in FIGS. 1, 2 is missing here. The electrical generator 152 (illustrated with a solid line), which here is obligatory, can be driven by means of the turbine 150 to generate electrical energy. The position control thruster 170 can, amongst other options, be supplied by means of line L3. Any desired division of the volumetric flows between the line L1 and the line L3 can be provided by means of a valve (not shown). The oxidizer 108 located in the second tank 106 in the form of the liquid hydrogen peroxide 110 can be pressurized by means of the oxidizer line 180 exiting from the separator unit 160, as indicated by the white arrow 186, in an analogous manner to the forms of embodiment of FIGS. 1, 2. As in FIGS. 1, 2, the dotted circles in the oxidizer and water vapor lines 180, 182 of the separator unit 160 just serve to illustrate the chemical compounds (O2, vaporous or gaseous H2O) flowing in these lines. The rocket propulsion system 300 is once again integrated into the space vehicle 136.

In a significant difference from the two forms of embodiment of FIGS. 1, 2, the third form of embodiment has, amongst other features, an electrolysis unit 302 together with associated lines, which is designed for high-pressure and/or high-temperature operation. The electrolysis unit 302, which preferably comprises at least one solid oxide electrolysis cell that conducts oxygen ions, is connected to the separator unit 160 by means of the water vapor line 182. The electrolysis unit 302 can, for example, be supplied with the electrical energy that is required for its operation by the electrical generator 152 that is driven by the turbine 150, or by another external electrical energy source (not shown). The electrolysis unit 302 is also assigned a high-energy hydrogen line 310 and a high-energy oxygen line 312 for purposes of discharging the reaction products H2 and O2 produced from the water supplied during electrolysis. The two dotted circles with the chemical symbols H2 and O2 contained therein, again merely serve to illustrate the substances discharged from the electrolysis cell 302 in the high-pressure and/or high-temperature legs 310, 312. The oxygen leg 312 of the electrolysis cell 302 is coupled to the oxidizer leg 180 of the separator unit 160.

In a further difference, in the third form of embodiment a first high-pressure storage tank 320 is connected to the hydrogen leg 310 for purposes of storing the hydrogen H2 supplied by the electrolysis cell 302. A further line L6 branches off from the hydrogen leg 310, by means of which line the fuel 104 stored in the first tank 102 can also be pressurized in the direction of the white arrow 184, so that both tanks 102, 106 are permanently pressurized and a reliable repeated ignition of the main engine 120 is ensured when required. In addition, the oxygen leg 312 of the electrolysis unit 302 is connected by means of a line L7 to a second high-pressure accumulator 322 for purposes of receiving the oxygen O2 supplied by the electrolysis unit 302.

The two high-pressure accumulators 320, 322 further allow the operation of a number of exemplary subsidiary or auxiliary systems of the rocket propulsion system 300, which are briefly explained below.

Thus, a further line L8 for hydrogen H2 is connected to the first high-pressure accumulator 320; this is connected to the main nozzle 124 of the main engine 120. Correspondingly, a further line L9 for oxygen O2 leads from the second high-pressure accumulator 322 to the main nozzle 124 of the main engine 120. In the event of an emergency, for example, this allows an increase in the specific impulse of the main engine 120, and the implementation of a complex thrust vector control of the main engine 120 in order to change the trajectory of the space vehicle 136 or similar; this is not possible with the first two forms of embodiment of the rocket propulsion system that are shown in FIGS. 1, 2.

Furthermore, two lines L10, 11 lead from the two high-pressure accumulators 320, 322 to the position control thruster 170, so that the latter can be operated with high-energy oxygen O2 and hydrogen H2. Compared to the supply with gaseous hydrogen peroxide via the line L3 starting from the gas generator 140 that is provided in the forms of embodiment of FIGS. 1, 2, this permits the generation of substantially higher specific impulses by means of the position control thruster 170.

In addition, in a deviation from the forms of embodiment in FIGS. 1, 2, a defensive unit 330, and/or a high-energy unit 332, are here connected to the high-pressure accumulators 320, 322 with the aid of further lines L(12, 13). The defensive unit 330 can, for example, be a light gas cannon (not shown), with a preferably integrated recoil compensation for purposes of accelerating a projectile to an exit velocity of up to 60 km/s. The light gas cannon can be operated by means of the hydrogen H2 and/or oxygen O2 stored in the high-pressure accumulators 320, 322. The hydrogen H2 serves as the light gas that accelerates the projectile, while a mixture of hydrogen H2 and oxygen O2 (oxyhydrogen gas) acts as the actual propellant charge, instead of black powder, etc. As a consequence, a considerable reduction in weight can be achieved compared to the use of black powder cartridges, while at the same time the discharge velocity is increased. A defined ejection of the acceleration gas H2 also ensures impulse equalization by means of a suitably positioned counter-nozzle, so that the position of the space vehicle 136 remains essentially unchanged.

In addition, the defensive unit 330 can be formed with a laser system (not shown), which can also be supplied with the oxygen O2 and hydrogen H2 from the two high-pressure accumulators 320, 322, and with the power from the electric generator 152.

The high-energy unit 332 can also take the form of any other device that also requires high-pressure hydrogen H2 and oxygen O2 for its operation.

In the area of undesignated connection or junction points (nodes) between the lines L8, 10 L9, 11 L10, 12 L11, 13 and others, valves, not shown, are preferably provided for purposes of controlling the passage and/or splitting of the respective material flows (O2, H2, H2O2, fuel, etc.), which may also be present in a liquid and/or a gaseous phase. In addition, valves can be provided on or in any sections of the lines.

As a further difference, an oxygen storage unit 340 and a water storage unit 342 can optionally be provided, so that a life support system (not shown) of the space vehicle 136 can, for example, be permanently supplied with oxygen O2 and water H20 for a human crew on board the space vehicle 136. This makes it possible to achieve longer stays in space or, as required, journeys to the Moon and/or near-Earth planets such as Mars. For this purpose, the oxygen storage unit 340 is connected to the oxidizer leg 180 of the separator unit 160 by means of a further line L14 and the water storage unit 342 is connected to the water leg 182 of the separator unit 160 via a line L15.

The third form of embodiment of the rocket propulsion system 300 can also be operated or utilized in an optimum manner with the aid of a large number of processes or sequences controlled by the controller and/or regulator.

Thus, for example, liquid hydrogen peroxide H2O2 from the second tank 106 can first be converted into gaseous hydrogen peroxide H2O2 by means of the gas generator 140, and then converted into electricity by means of the turbine 140 and the electric generator 150.

The gaseous hydrogen peroxide exiting from the turbine 150 via the line L2 is split into oxygen O2 and water H2O using the separator unit 160. The oxygen O2 and the liquid and/or vaporous water H2O can then be stored for longer periods in an oxygen storage unit 340 and in a water storage unit 342 for further use. The water H2O exiting from the separator unit 160 is decomposed by means of the electrolysis unit 302 into hydrogen H2 and oxygen O2; these are permanently stored separately from one another, in a first high-pressure storage unit 320 for H2, and in a second high-pressure storage unit 322 for O2, for any future use.

Possible uses of the hydrogen H2 and oxygen O2 stored under high-pressure in the high-pressure accumulators 320, 322 include, for example, injection into the main nozzle 124 of the main engine 120, supplying the position control thruster 170, and supplying the defensive unit 330 in the form of a light gas canister, or the high-energy unit 332 (for subsidiary or auxiliary drives).

Needless to say, a large number of other methods or processes are possible, in each case under the control of the electronic controller and/or regulator (not shown), for purposes of operating the rocket propulsion system 300 in accordance with the third form of embodiment of FIG. 3.

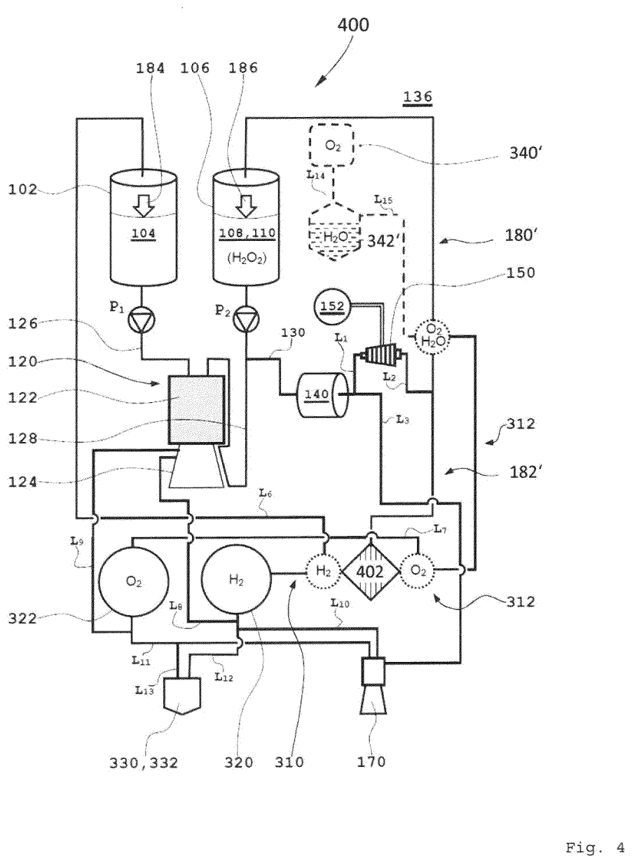

FIG. 4 illustrates a schematic flow diagram of a fourth form of embodiment of a rocket propulsion system. This form of embodiment of a rocket propulsion system 400 comprises an electrolysis unit (402), which in the present case comprises a proton-conducting solid oxide electrolysis cell. In comparison to the form of embodiment shown in FIG. 3, the separator unit 160 is thus omitted, and the exhaust gas from the turbine 150 can be supplied directly to the electrolysis unit 402. In this form of embodiment, the oxidizer leg 180′ carries not only oxygen but also water vapor, and the water vapor leg 182′ becomes a conversion leg which, like the oxidizer leg 180′, contains a water vapor/oxygen mixture, except that the supply is directly to the electrolysis unit 402. The optional water unit 342′ and oxygen storage unit 340′ can be accommodated together on the oxidizer leg 180′.

The invention relates to a rocket propulsion system comprising a first tank and a second tank, wherein the first tank is filled with a fuel, and the second tank is filled with an oxidizer, such as liquid hydrogen peroxide, for purposes of supplying at least one preferably repeatedly ignitable main engine of the rocket propulsion system. A gas generator is associated with the rocket propulsion system; this is designed to generate vaporous hydrogen peroxide. After flowing through at least one turbine, the hydrogen peroxide can, at least partially, be supplied to a separator unit, which is designed to break down vaporous hydrogen peroxide into water vapor and gaseous oxygen. Alternatively, or additionally, the hydrogen peroxide can be supplied to an electrolysis unit, which is designed to generate gaseous oxygen and gaseous hydrogen from the hydrogen peroxide supplied to it, and/or from water vapor that is located downstream. By this means, the rocket propulsion system, including all its subsidiary systems, can be operated with hydrogen peroxide H2O2 as an environmentally compatible oxidizer in conjunction with a liquid, storable fuel that is also as low in toxicity as possible.

The invention also relates to a method for the operation of the rocket propulsion system, and to a space vehicle.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SYMBOLS

100 Rocket propulsion system (1st variant)
102 First tank
104 Fuel
106 Second tank
108 Oxidizer
110 Hydrogen peroxide
120 Main engine
122 Combustion chamber (main engine)
124 Main nozzle (main engine, nozzle skirt)
126 First main supply line (oxidizer)
128 Second main supply line (fuel)
130 Branch line
136 Space vehicle
140 Gas generator
150 Turbine
152 Electric generator
154 Bypass branch (turbine)
160 Separator unit
170 Position control thruster
180, 180′ Oxidizer leg (separator unit)
182, 182′ Water vapor leg (separator unit)
184 White arrow
186 White arrow
200 Rocket propulsion system (2nd variant)
202 Vessel (inert gas)
210 Inert gas
300 Rocket propulsion system (3rd variant)
302 Electrolysis unit (high pressure/high temperature)
310 (High-energy) hydrogen leg
312 (High-energy) oxygen leg
320 First high-pressure accumulator (hydrogen)
322 Second high-pressure accumulator (oxygen)
330 Defensive unit
332 High-energy unit
340, 340′ Oxygen storage unit
342, 342′ Water storage unit
400 Rocket propulsion system (4th variant)
402 Electrolysis unit
L₁ Line (turbine)
L₂ Line (turbine)
L₃ Line (position control thruster)
L₄ Line (pressurization of first tank)
L₅ Line (pressurization of second tank)
L₆ Line (pressurization of first tank)
L₇ Line (connection to first high-pressure accumulator)
L₈ Line (main nozzle)
L₉ Line (main nozzle)
L₁₀ Line (position control thruster)
L₁₁ Line (position control thruster)
L₁₂ Line (defensive/high-energy unit)
L₁₃ Line (defensive/high-energy unit)
L₁₄ Line (oxygen storage unit)
L₁₅ Line (water storage unit)
P₁ Fuel pump
P₂ Oxidizer pump

1.-16. (canceled)

17. A rocket propulsion system comprising:
a first tank and a second tank,
wherein the first tank is filled with a fuel, and the second tank is filled with an oxidizer for purposes supplying at least one engine of the rocket propulsion system,
wherein the rocket propulsion system is assigned a gas generator to generate vaporous hydrogen peroxide, which, after flowing through at least one turbine may be, at least partially, supplied to a separator unit for separating vaporous hydrogen peroxide into water vapor and gaseous oxygen, or, which, after flowing through at least one turbine may be, at least partially, supplied to an electrolysis unit to generate gaseous oxygen and gaseous hydrogen from the vaporous hydrogen peroxide, or from water vapor that is located downstream, or from both, or which, after flowing through at least one turbine may be, at least partially, supplied to the separator unit and the electrolysis unit.

18. The rocket propulsion system according to claim 17, wherein the gas generator supplies at least one position control thruster with vaporous hydrogen peroxide.

19. The rocket propulsion system according to claim 17, wherein an electrical generator, or at least one fuel pump, or an oxidizer pump, or any combination thereof, is driven with the at least one turbine.

20. The rocket propulsion system according to claim 17, wherein the vaporous hydrogen peroxide is at least partially be supplied to the separator unit after flowing through the at least one turbine,
wherein the first tank is pressurized with a water vapor leg of the separator unit, and the second tank is pressurized with an oxidizer leg of the separator unit.

21. The rocket propulsion system according to claim 20, further comprising:
at least one vessel with an inert gas for at least supplementary pressurization of the first tank, the second tank, or both.

22. The rocket propulsion system according to claim 17, wherein the vaporous hydrogen peroxide is, at least partially, be supplied to a separator unit after flowing through the at least one turbine,
wherein the second tank is pressurized with an oxidizer leg of the separator unit, and an electrolysis unit is connected to the separator unit with a water vapor leg, and
wherein the electrolysis unit has a high-energy hydrogen leg and an oxygen leg.

23. The rocket propulsion system according to claim 22, wherein an oxygen storage unit is assigned to the oxidizer leg of the separator unit, and a water storage unit is assigned to the water vapor leg of the separator unit.

24. The rocket propulsion system according to claim 23, wherein a first high-pressure accumulator is assigned to the high-energy hydrogen leg, and a second high-pressure accumulator is assigned to the high-energy oxygen leg.

25. The rocket propulsion system according to claim 24, wherein the first tank is pressurized with the high-energy hydrogen leg.

26. The rocket propulsion system according to claim 24, wherein a main nozzle of the engine is charged with hydrogen from the first high-pressure accumulator, and is charged with oxygen from the second high-pressure accumulator.

27. The rocket propulsion system according to claim 24, wherein at least one position control thruster, at least one defensive unit, a high-energy unit, or any combination thereof is supplied by the first and second high-pressure accumulators.

28. The rocket propulsion system according to claim 17, wherein the vaporous hydrogen peroxide is, at least partially, supplied to the electrolysis unit after flowing through the at least one turbine,
wherein the rocket propulsion system has a working gas leg for a working gas mixture exiting from the turbine,
wherein the working gas leg comprises a conversion leg for purposes of supplying the working gas mixture to the electrolysis unit, and an oxidizer leg for pressurizing the second tank, and
wherein the electrolysis unit has a high-energy hydrogen and oxygen leg.

29. The rocket propulsion system according to claim 17, wherein the rocket propulsion system is configured to be operated in an engine cycle with a fuel leg switched off:
in a monopropellant mode, or
with a main propulsion system switched off, for operating a position control system, for pressurizing the first tank, the second tank, or both, for providing a working gas for at least one external system, or any combination thereof.

30. A method for operating the rocket propulsion system according to claim 17, comprising:
suppling the fuel to the engine via a first main supply line, and
tapping, at least partially, a liquid hydrogen peroxide from a second main supply line of the engine and supplied to the gas generator.

31. The method according to claim 30, wherein the vaporous hydrogen peroxide exiting from the gas generator is, at least partially, supplied to the turbine.

32. A space vehicle comprising:
at least one rocket propulsion system according to claim 17.
